(19) United States
(12) Patent Application Publication
(10) Pub. No.: US 2016/0271856 A1
(43) Pub. Date: Sep. 22, 2016

(54) POLYMER EXTRUSION ASSEMBLY AND METHOD FOR THE DETECTION OF FAILURE OF CUTTER BLADES IN POLYMER EXTRUSION ASSEMBLY

(71) Applicants: SAUDI BASIC INDUSTRIES CORPORATION, Riyadh (SA); SABIC GLOBAL TECHNOLOGIES B.V., PX Bergen op Zoom (NL)

(72) Inventors: Naresh Sundararaman Iyer, Jubail Industrial City (SA); Sachithananthan Swaminathan, Jubail Industrial City (SA); Ravindra K. Dosaj, Jubail Industrial City (SA)

(21) Appl. No.: 14/410,257

(22) PCT Filed: Oct. 21, 2014
(86) PCT No.: PCT/EP2014/072519

§ 371 Date: Dec. 22, 2014

(30) Foreign Application Priority Data
Oct. 21, 2013 (EP) 13005012.3

(51) Int. Cl. B29C 47/92; G06F 17/30; G06K 9/62; G06T 7/00; B29C 47/00; B29C 47/12

(52) U.S. Cl. CPC B29C 47/92; B29C 47/0066; B29C 47/12; G06K 9/6201; G06T 7/001; G06F 17/30256; B29C 2947/92295; B29C 2947/92409; B29C 2947/92466; G06T 2207/30164

(57) ABSTRACT

The present invention relates to a polymer extrusion assembly and method for the detection of failure of cutter blades in polymer extrusion assembly, the assembly comprising: an extruder plate, a rotatable cutter assembly, a structured light, a detection mechanism, a reconstructing mechanism, and an analyzing mechanism capable of analyzing said image. The present invention allows for online condition monitoring of both the die plate and the knife set.

### CROSS-REFERENCE TO RELATED APPLICATION

This application is a U.S. National Stage of International Application No. PCT/EP2014/072519, filed on Oct. 21, 2014 and claims the benefit of U.S. Provisional Application Ser. No. 62/065,821 filed on Oct. 20, 2014 and European Patent Application 13005012.3 filed on Oct. 21, 2013, the disclosures of which are incorporated herein by reference in their entirety.

### TECHNICAL FIELD

The present invention relates to a polymer extrusion assembly and method for the detection of failure of cutter blades in a polymer extrusion assembly.

### BACKGROUND

A polymer extrusion assembly as such is known from US patent application No. US2007/0172533. This US 2007/0172533 discloses a cutting assembly for cutting a material extruded from an extruder plate, the assembly comprising: an extruder plate, a cutter assembly and, a cutter control system, said cutter control system including a control that is designed to process at least one type of detected information from at least one type of detector and to use such detected information to at least partially control a rate of cutting of said material by said cutter blade.

Polymer extrusion assemblies are also known from WO2010021814, which document relates to knife assemblies of the kind commonly used with extruders to cut extrudates on a continuous basis, wherein the knife assemblies include an adjustment mechanism allowing axial adjustment of the cutting knives relative to an extruder die.

Improved polymer extrusion assemblies are desired as well as improved methods of extruding.

### BRIEF SUMMARY

In an embodiment, a polymer extrusion assembly that comprises an extruder plate that includes an inner face and a front face and at least one die opening; a feed arrangement designed to feed polymer material towards said inner face of said extruder plate to cause said material to at least partially pass through said at least one die opening; a rotatable cutter assembly that includes a least one cutter blade, said cutter assembly design causing said cutter blade to move so as to at least partially cut said material passing through said at least one die opening in said extruder plate, said cutter blade positioned at least closely adjacent to said front face of said extruder plate. The polymer extrusion assembly further comprises: a structured light source for irradiating one or more of the at least one cutter blade, the front face of said extruder plate, and the interface between the at least one cutter blade and said front face of said extruder plate; a detection mechanism capable of detecting the light reflected from one or more of the at least one cutter blade, the front face of said extruder plate, and said interface; a reconstructing mechanism capable of reconstructing the detected light image; and an analyzing mechanism capable of analyzing said image.

In another embodiment, a method for the detection of failure of cutter blades in a polymer extrusion assembly comprises the steps of: i) feeding polymer material toward said inner face of said extruder plate through said at least one die opening; cutting said material passing through said at least one die opening in said extruder plate; capturing an image of at least one of rotating cutter blade, the front face of said extruder plate, and the interface between the at least one cutter blade and said front face of said extruder plate; comparing the actual image of iii) with an image of the item under iii) concerned, said image being stored in a memory database; providing a signal on basis of said comparison. The assembly comprises: an extruder plate that includes an inner face and a front face and at least one die opening; a feed arrangement designed to feed polymer material towards said inner face of said extruder plate to cause said material to at least partially pass through said at least one die opening; and a rotatable cutter assembly that includes a least one cutter blade, said cutter assembly design causing said cutter blade to move so as to at least partially cut said material passing through said at least one die opening in said extruder plate, said cutter blade positioned at least closely adjacent to said front face of said extruder plate.

### DETAILED DESCRIPTION

An existing aspect of polymer extrusion assemblies is the inspection or determination of the knife quality. Extrusion machines consist of a set of knives arranged radially perpendicular to the axis of the motor. If the knife quality is deteriorated, the product thus cut will be not acceptable. In addition, to determine the actual status of the knives one need to open the extruder resulting in a shut down of the process and equipment. This means that there is a visual inspection of the knife edge and the die plate. The present practice does not allow for condition monitoring of the knife set or die plate while the extrusion machine is running or operational.

The present inventors found that the existing practice in this technical field is that when an extrusion machine is started-up after repair or commissioned initially, the interface is inspected visually for quality of individual surfaces or the result of cutting action, namely, polymer pellet size and shape. In addition, when there is a “polymer thrash out”—a condition known due to agglomerated chunks of polymer coming out of the extruder, the extruder machine is opened and the knife set and die-plate are inspected for defects. It is noted that polymer thrash out could be due to other process parameters like variation in viscosity of the polymer melt etc. Moreover, when pellet size and shape are defective—the extrusion machine is again stopped and the extruder is opened for inspection.

On the other hand, JP2004230874 relates to assemblies for visualizing the interior of hot cutting devices by means of taking images with a camera via an optical fiber scope positioned inside the cutting case, which may have a light source for illumination in case the amount of light in the case is insufficient.

JP2010030105 discloses a hot cutting device for waste plastics extrusion, in which a fiberscope camera is positioned in the cutting case together with a light source. Image analysis is performed by an operator in a control room.

JP05096533 presents a pelletizing device for polymers in which a means for adjustment of the gap between the cutter blade and the extruder die plate is present. The gap distance is measured by an optical displacement meter, based on the value of which an operator may adjust the cutter blade.

Another aspect of polymer extrusion assemblies is that the wear pattern of individual knives can differ from one knife to the others.

Another aspect of polymer extrusion assemblies is the determination of the quality of the die plate. The die plate as such can show extensive wear which has a substantial influence on the product leaving the die plate.

Another aspect of polymer extrusion assemblies is the lack of an assured indicator for starting up the extruder after replacement of a knife set or replacement of a die-plate.

Another aspect of polymer extrusion assemblies is the need of an online or continuous monitoring of knife quality.

The present invention is related to one or more of the above mentioned aspects and provides a polymer extrusion assembly, the assembly comprising:

an extruder plate that includes an inner face and a front face and at least one die opening; a feed arrangement designed to feed said polymer material toward said inner face of said extruder plate to cause said material to at least partially pass through said at least one die opening;

a rotatable cutter assembly that includes a least one cutter blade, said cutter assembly design cause said cutter blade to move so as to at least partially cut said material passing through said at least one die opening in said extruder plate, said cutter blade positioned at least closely adjacent to said front face of said extruder plate; and,

a structured light source for irradiating one or more of the at least one cutter blade, the front face of said extruder plate, the interface between the at least one cutter blade and said front face of said extruder plate;

a detection mechanism capable of detecting the light reflected from one or more of the at least one cutter blade, the front face of said extruder plate and said interface;

a reconstructing mechanism capable of reconstructing the detected light in an image; and

an analyzing mechanism capable of analyzing said image.

The present inventors found that with the present polymer extrusion assembly as mentioned above frequent start-stop of the extrusion machine for inspection to address, inter alia, the above discussed “polymer trash” can be avoided. In addition, the present polymer extrusion assembly involves non-contact type of detection hence it is not affected by failure modes that are associated with rotating elements. Moreover, the present polymer extrusion assembly provides visual feedback and reconstructed evidence for a continuous process that is inside an enclosure, thus giving an ability to correlate cause and effect during failure analysis. And the present polymer extrusion assembly provides information for advancing the knife against the die plate to maintain constant pressure over varying wear conditions that are within permissible operational ranges for the cutting process. In fact, the present invention allows for online condition monitoring of both the die plate and the knife set. These and other advantages will become apparent to those skilled in the art upon the reading and following of this description taken together with the accompanying schematic drawings. These drawings are used for the purpose of illustrating preferred embodiments of the present invention only and not for the purpose of limiting the same.

In a preferred embodiment the detection mechanism comprises a camera.

In a preferred embodiment the analyzing mechanism comprises a memory database in which images of each of said cutter blades, said front face of said extruder plate, and said interface between the at least one cutter blade and said front face of said extruder plate are stored.

The analyzing mechanism further comprises means for comparing an actual image of said cutter blade with an image of said cutter blade stored in said memory database and means for providing a signal on basis of said comparison.

According to another embodiment the analyzing mechanism further comprises means for comparing an actual image of said front face of said extruder plate with an image of said front face of said extruder plate stored in said memory database and means for providing a signal on basis of said comparison.

According to another preferred embodiment the analyzing mechanism further comprises means for comparing an actual image of said interface between the at least one cutter blade and said front face of said extruder plate with an image of said interface between the at least one cutter blade and said front face of said extruder plate stored in said memory database and means for providing a signal on basis of said comparison.

The present invention further relates to a method for the detection of failure of cutter blades in a polymer extrusion assembly, the assembly comprising an extruder plate that includes an inner face and a front face and at least one die opening; a feed arrangement designed to feed said polymer material toward said inner face of said extruder plate to cause said material to at least partially pass through said at least one die opening and a rotatable cutter assembly that includes a least one cutter blade, said cutter assembly design cause said cutter blade to move so as to at least partially cut said material passing through said at least one die opening in said extruder plate, said cutter blade positioned at least closely adjacent to said front face of said extruder plate, wherein the present method comprises the steps of:

i) Feeding polymer material toward said inner face of said extruder plate through said at least one die opening;

ii) Cutting said material passing through said at least one die opening in said extruder plate;

iii) Capturing an image of at least one of rotating cutter blade, the front face of said extruder plate, and the interface between the at least one cutter blade and said front face of said extruder plate;

iv) Comparing the actual image of iii) with an image of the item under iii) concerned, said image being stored in a memory database;

v) Providing a signal on basis of said comparison.

According to a preferred embodiment of the present method for the detection of failure of cutter blades in a polymer extrusion assembly the method further comprises, before starting the extrusion process, capturing an image of at least one of a cutter blade, the front face of said extruder plate, and the interface between the at least one cutter blade and said front face of said extruder plate, and storing each image thus captured in a memory database as a reference for start-up condition.

According to another embodiment the present method further comprises, before starting the extrusion process, capturing an image of a chipped cutter blade, and storing said image thus captured in a memory database as a reference for unacceptability of the chipped cutter blade.

The present method for the detection of failure of cutter blades in a polymer extrusion assembly further comprises preferably, before starting the extrusion process, capturing an image of a used extruder plate and storing said image thus captured in a memory database as a reference for unacceptability of the used extruder plate.

In the present method for the detection of failure of cutter blades in a polymer extrusion assembly it is especially preferred that the method further comprises comparing said image of an used extruder plate and said image of a chipped cutter blade and storing said image thus created in a memory database as a reference for unacceptability of the interface between the chipped cutter blade and said front face of said used extruder plate.

The method further comprises reconstructing a 3-D image of the images captured. Such a reconstruction is carried out through “stitching” by software.

According to a preferred embodiment of the present method for the detection of failure of cutter blades in a polymer extrusion assembly the method further comprises capturing images during cutter blade honing of the interface between the cutter blade and said front face of said extruder plate, especially further comprising capturing images during cutter blade honing of the extruder plate.

The present method for the detection of failure of cutter blades in a polymer extrusion assembly is further characterized in that the method further comprises comparing said images captured during cutter blade honing with images captured as a reference for start-up condition for providing a filter mechanism for eliminating the presence of any water.

According to another embodiment it is preferred that during the extrusion process, the method further comprises capturing an image of at least one of rotating cutter blade, the front face of said extruder plate, and the interface between the at least one cutter blade and said front face of said extruder plate and applying said filter mechanism for eliminating the presence of any water for obtaining water filtered images of at least one of rotating cutter blade, the front face of said extruder plate, and the interface between the at least one cutter blade and said front face of said extruder plate.

Since water droplets may interfere with the analysis or interpretation of the images obtained it is preferred that the method further comprises applying a filter mechanism for the presence of polymer material on said water filtered images of at least one of rotating cutter blade, the front face of said extruder plate, and the interface between the at least one cutter blade and said front face of said extruder plate for obtaining water and polymer material filtered images of at least one of rotating cutter blade, the front face of said extruder plate, and the interface between the at least one cutter blade and said front face of said extruder plate.

In addition, the method for the detection of failure of cutter blades in a polymer extrusion assembly further comprises comparing the water and polymer material filtered images of at least one of rotating cutter blade, the front face of said extruder plate, and the interface between the at least one cutter blade and said front face of said extruder plate with the relevant images stored in a memory database as a reference for unacceptability and stored as a reference for start-up condition.

The present invention will now be discussed by way of a non-limiting example.

### Example

This example is given by way of individual procedural steps.

Step 1: Photograph each knife of a new knife set which has undergone an inspection check. Store the image with knife number in a memory. Several photographs need to be taken for reconstructing a 3-D image.

Step 2: Create a 3-D image for each knife with reference number using photographs.

Step 3: Photograph the die plate after inspection and perform similar recreation through 3D reconstruction at required surface roughness (unevenness) value.

Step 4: Modify the polymer extrusion machine housing by placing the detection mechanism. This detection mechanism may include the light source.

Step 5: Repeat exercise mentioned under step 1, step 2, and step 3.

Step 6: Compare the outputs in step 1, step 2, and step 3 with the output in step 5 to arrive at a good image of knife-die plate interface. These outputs will provide the master images for the knife edge, die plate surface, and the knife-die plate interface for a good start-up condition.

Step 7: Repeat exercise step 1 and step 2 with an acceptable but minutely chipped knife to create a reference for an unacceptable alarm.

Step 8: Repeat step 3 with a used die plate that is acceptable after a minimum specified days of usage. This will create a reference for the unacceptable alarm.

Step 9: Repeat step 7 and step 8.

Step 10: Compare the outputs in step 7 and step 8 with the output in step 9 to arrive at a reference image of knife-die plate interface. These will provide the master images for the knife edge, die plate surface, and the knife-die plate interface for unacceptability alarm.

Step 11: Capture the images during knife honing for the interface and die plate zone. Similarly create reference images for start-up in running condition. Compare with images from step 6 to provide for a software filter that will eliminate the presence of water.

Step 12: Start-up the extrusion machine and take images in running condition with the filter for water in place. This will give images of the knife edge, die plate surface, and the knife-die plate interface which are marred by presence of polymer pellets.

Step 13: Use software technique to filter polymer pellets from the images acquired in step 12.

Step 14: Now using the water filter and the polymer pellet filter capture images of knife edge, die-plate surface, and the knife-die plate interface for regular periodic comparison with the images in step 6 and step 8 to provide online monitoring heuristic.

Step 15: Create, update and maintain a table of correct and incorrect decisions regarding knife-set/die-plate replacement based on initial heuristic on a “hit/miss” type of strategy with recording a “hit” for every correct replacement and “miss” for every incorrect one.

Step 16: Periodically review the table in step 15 to improve the heuristic.

The present invention relates to the provision of a method to detect failure of knives, also known as cutters, in a typical polymer extrusion machine by use of structured light or laser. The structured light source is especially a laser diode operating in the red-infrared wavelength. The present invention comprises the placement of a structured light source within the housing of a polymer extrusion machine. The present invention also entails a suitable detection mechanism, for example a camera that is capable of detecting the light reflected from the knife edge. In a preferred embodiment the detection mechanism is a charge-coupled camera with detection capability in the same wavelength range as the laser diode, said laser diode being the preferred embodiment of the structured light source.

As mentioned above, the structured light illuminates the knife edge continuously, while the knife edge is in contact with the die plate, i.e. the surface against which the polymer is cut into pieces or pellets. In a normal condition, a nominal uniform gap exists between the knife edge and the die plate or in case of certain polymers like polypropylene the knife edge presses against the die plate without any gap. In both cases, the uniformity of the interface between the knife edge and the die plate is correlated to the quality of the knife. When the structured light reflects from this interface it is uniform in its distribution due to the quality of the interface. Whenever there is deterioration in the interface due to a crack on the knife or unevenness on the die plate, the quality of the interface deteriorates providing instantaneous feedback through the detection mechanism. Since the illumination is continuous, the capability of determining the quality of the interface is also continuous. Specific software is used to reconstruct the captured images or detected profiles to enable a visualization of the knife edge interface with the die plate enabling determination of the quality of the interface and consequent decision making without stopping the machine and opening it for inspection.

1. A polymer extrusion assembly, the assembly comprising:
an extruder plate that includes an inner face and a front face and at least one die opening;
a feed arrangement designed to feed polymer material towards said inner face of said extruder plate to cause said material to at least partially pass through said at least one die opening;
a rotatable cutter assembly that includes a least one cutter blade, said cutter assembly design causing said cutter blade to move so as to at least partially cut said material passing through said at least one die opening in said extruder plate, said cutter blade positioned at least closely adjacent to said front face of said extruder plate;
characterized in that said polymer extrusion assembly further comprises:
a structured light source for irradiating one or more of the at least one cutter blade, the front face of said extruder plate, and the interface between the at least one cutter blade and said front face of said extruder plate;
a detection mechanism capable of detecting the light reflected from one or more of the at least one cutter blade, the front face of said extruder plate, and said interface;
a reconstructing mechanism capable of reconstructing the detected light image; and
an analyzing mechanism capable of analyzing said image.

2. The polymer extrusion assembly according to claim 1, wherein the detection mechanism comprises a camera.

3. The polymer extrusion assembly according to claim 1, wherein said analyzing mechanism comprises a memory database in which images of each of said cutter blades, said front face of said extruder plate, and said interface between the at least one cutter blade and said front face of said extruder plate are stored.

4. The polymer extrusion assembly according to claim 3, wherein said analyzing mechanism further comprises means for comparing:
an actual image of said cutter blade with an image of said cutter blade stored in said memory database; and/or
an actual image of said front face of said extruder plate with an image of said front face of said extruder plate stored in said memory database; and/or
an actual image of said interface between the at least one cutter blade and said front face of said extruder plate with an image of said interface between the at least one cutter blade and said front face of said extruder plate stored in said memory database
and means for providing a signal on basis of said comparison.

5. A method for the detection of failure of cutter blades in a polymer extrusion assembly, the assembly comprising:
an extruder plate that includes an inner face and a front face and at least one die opening;
a feed arrangement designed to feed polymer material towards said inner face of said extruder plate to cause said material to at least partially pass through said at least one die opening; and
a rotatable cutter assembly that includes a least one cutter blade, said cutter assembly design causing said cutter blade to move so as to at least partially cut said material passing through said at least one die opening in said extruder plate, said cutter blade positioned at least closely adjacent to said front face of said extruder plate;
characterized in that the method comprises the steps of:
i) feeding polymer material toward said inner face of said extruder plate through said at least one die opening;
ii) cutting said material passing through said at least one die opening in said extruder plate;
iii) capturing an image of at least one of rotating cutter blade, the front face of said extruder plate, and the interface between the at least one cutter blade and said front face of said extruder plate;
iv) comparing the actual image of iii) with an image of the item under iii) concerned, said image being stored in a memory database;
v) providing a signal on basis of said comparison.

6. The method for the detection of failure of cutter blades in a polymer extrusion assembly according to claim 5, wherein the method further comprises, before starting the extrusion process, capturing an image of at least one of a cutter blade, the front face of said extruder blade, and the interface between the at least one cutter blade and said front face of said extruder plate, and storing each image thus captured in a memory database as a reference for start-up condition.

7. The method for detection of failure of cutter blades in a polymer extrusion assembly according to claim 5, wherein the method further comprises:
before starting the extrusion process:
capturing an image of a chipped cutter blade and storing said image thus captured in a memory database as a reference for unacceptability of the chipped cutter blade; and/or
capturing an image of a used extruder plate and storing said image thus captured in a memory database as a reference for unacceptability of the used extruder plate; and/or
capturing an image of a chipped cutter blade, capturing an image of a used extruder plate, and comparing said image of a used extruder plate and said image of a chipped cutter blade and storing said image thus created in a memory database as a reference for unacceptability of the interface between the chipped cutter blade and said front face of said used extruder plate.

8. The method for the detection of failure of cutter blades in a polymer extrusion assembly according to claim 5, wherein the method further comprises reconstructing a 3-D image of the images captured.

9. The method for the detection of failure of cutter blades in a polymer extrusion assembly according to claim 5, wherein the method further comprises capturing images during cutter blade honing of the interface between the cutter blade and said front face of said extruder plate.

10. The method for the detection of failure of cutter blades in a polymer extrusion assembly according to claim 5, wherein the method further comprises capturing images during cutter blade honing of the extruder plate.

11. The method for detection of failure of cutter blades in a polymer extrusion assembly according to claim 5, wherein the method further comprises comparing said images captured during cutter blade honing with images captured as reference for start-up condition for providing a filter mechanism for eliminating the presence of any water.

12. The method for the detection of failure of cutter blades in a polymer extrusion assembly according to claim 11, wherein the method further comprises, during the extrusion process, capturing an image of at least one of the rotating cutter blade, the front face of said extruder plate, and the interface between the at least one cutter blade and said front face of said extruder plate and applying said filter mechanism for eliminating the presence of any water for obtaining water filtered images of at least one of rotating cutter blade, the front face of said extruder plate, and the interface between the at least one cutter blade and said front face of said extruder plate.

13. The method for the detection of failure of cutter blades in a polymer extrusion assembly according to claim 12, wherein the method further comprises applying a filter for the presence of polymer material on said water filtered images of at least one of rotating cutter blade, the front face of said extruder plate, and the interface between the at least one cutter blade and said front face of said extruder plate for obtaining water and polymer filtered images of at least one of rotating cutter blade, the front face of said extruder plate, and the interface between the at least one cutter blade and said front face of said extruder plate.

14. The method for the detection of failure of cutter blades in a polymer extrusion assembly, according to claim 13, wherein the method further comprises comparing the water and polymer filtered images of at least one of rotating cutter blade, the front face of said extruder plate, and the interface between the at least one cutter blade and said front face of said extruder plate with the relevant images stored in a memory database as a reference for unacceptability and stored as a reference for start-up condition.
